(19) United States
(12) Patent Application Publication
(10) Pub. No.: US 2022/0180183 A1
(43) Pub. Date: Jun. 9, 2022

(54) METHOD, APPARATUS, AND SYSTEM FOR PROVIDING PLACE CATEGORY PREDICTION

(71) Applicant: HERE Global B.V., Eindhoven (NL)

(72) Inventor: Soojung HONG, Zurich (CH)

(21) Appl. No.: 17/116,724

(22) Filed: Dec. 9, 2020

(51) Int. Cl. G06N 3/08; G06K 9/62; G06F 16/242; G06F 16/29

(52) U.S. Cl. CPC G06N 3/08; G06F 16/29; G06F 16/244; G06K 9/6259

(57) ABSTRACT

An approach is provided for place category prediction. The approach, for instance, involves identifying a place located in a geographic area and constructing a place graph comprising the place as a place node and one or more neighbor nodes representing one or more neighboring places in the geographic area. The approach also involves encoding the place graph using a graph convolutional network (e.g., by training the network). The graph convolutional network, for instance, is trained using at least one message propagation method of a plurality of differentiated message propagation methods. The approach further involves using the graph convolutional network with the encoded place graph to predict a category of the place and providing the predicted category of the place as an output.

### BACKGROUND

Mapping service providers face significant technical challenges to maintaining up-to-date and accurate mapping data. For example, discovering new points of interest (POIs) or places (e.g., restaurants, stores, etc.) can be particularly challenging because of the relatively high rate of change for such places (e.g., as new places are established or existing places change). Once new or updated places are discovered, service providers face even more technical challenges with respect to determining the category or type of the place. For example, analysis of imagery data may identify that a new place has been opened but determining the corresponding place category (e.g., whether the place is a store, restaurant, bar, office, etc.) remains technically difficult to achieve, for example, without expending significant resources to manually survey and identify the place.

### SOME EXAMPLE EMBODIMENTS

Therefore, there is a need to automate place category prediction for newly discovered or updated places or other map features.

According to one embodiment, a method comprises identifying a designated place (e.g., a newly discovered place or other map feature) located in a geographic area. The method also comprises receiving or constructing a place graph comprising one or more place nodes representing one or more places in the geographic area and one or more edges representing one or more neighboring relationships between the one or more places. The method further comprises encoding the place graph using a graph convolutional network, wherein the graph convolutional network is trained using at least one message propagation method of a plurality of differentiated message propagation methods. The method further comprises using the graph convolutional network with the encoded place graph to predict a category of the designated place (e.g., the category is the predicted label of a graph node representing the designated place). The method further comprises providing the predicted category of the designated place as an output.

According to another embodiment, an apparatus comprises at least one processor, and at least one memory including computer program code for one or more computer programs, the at least one memory and the computer program code configured to, with the at least one processor, cause, at least in part, the apparatus to identify a designated place (e.g., a newly discovered place or other map feature) located in a geographic area. The apparatus is also caused to receive or construct a place graph comprising (1) one or more place nodes representing one or more places in the geographic area including the designated place, and (2) one or more edges representing one or more neighboring relationships between the one or more places and the designated place. The apparatus is further caused to encode the place graph using a graph convolutional network. The graph convolutional network, for instance, is trained using at least one message propagation method of a plurality of differentiated message propagation methods. The apparatus is further caused to use the graph convolutional network with the encoded place graph to predict a category of the designated place (e.g., the category is the predicted label of the node of the place graph corresponding to the designated place). The apparatus is further caused to provide the predicted category of the designated place as an output.

According to another embodiment, a non-transitory computer-readable storage medium carries one or more sequences of one or more instructions which, when executed by one or more processors, cause, at least in part, an apparatus to identify a designated place (e.g., a newly discovered place or other map feature) located in a geographic area. The apparatus is also caused to receive or construct a place graph comprising (1) one or more place nodes representing one or more places in the geographic area including the designated place, and (2) one or more edges representing one or more neighboring relationships between the one or more places and the designated place. The apparatus is further caused to encode the place graph by a training process of a graph convolutional network. The graph convolutional network, for instance, is trained using at least one message propagation method of a plurality of differentiated message propagation methods. The apparatus is further caused to use the graph convolutional network with the encoded place graph to predict a category of the designated place (e.g., the category is the predicted label of the node of the place graph corresponding to the designated place). The apparatus is further caused to provide the predicted category of the designated place as an output.

According to another embodiment, an apparatus comprises means for identifying a designated place (e.g., a newly discovered place or other map feature) located in a geographic area. The apparatus also comprises means for constructing a place graph comprising (1) one or more place nodes representing one or more places in the geographic area including the designated place, and (2) one or more edges representing one or more neighboring relationships between the one or more places and the designated place. The apparatus further comprises means for encoding the place graph using a machine learning model (e.g., a graph convolutional network or equivalent). The graph convolutional network, for instance, is trained using at least one message propagation method of a plurality of differentiated message propagation methods. The apparatus further comprises means for using the graph convolutional network with the encoded place graph to predict a category of the designated place (e.g., the category is the predicted label of the node of the place graph corresponding to the designated place). The apparatus further comprises means for providing the predicted category of the designated place as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing place category prediction, according to one embodiment;

FIG. 2 is a diagram of components of a mapping platform capable of providing place category prediction, according to one embodiment;

FIG. 3 is a flowchart of a process for providing place category prediction, according to one embodiment;

FIG. 4 is a diagram illustrating an example of a place for which a place category prediction is to be made, according to one embodiment;

FIG. 5 is a diagram illustrating an example of a place and its neighboring places, according to one embodiment;

FIG. 6 is a diagram illustrating an example of place encoding vectors, according to one embodiment;

FIG. 7 is a diagram illustrating an example of a place graph read-out and how messages are propagated to a connected node, according to one embodiment;

FIG. 8 is a diagram illustrating example aggregation function types, according to one embodiment;

FIG. 9 is a diagram illustrating a mapping user interface presenting predicted place category information, according to one embodiment;

FIG. 10 is a diagram of a geographic database, according to one embodiment;

FIG. 11 is a diagram of hardware that can be used to implement an embodiment of the processes described herein;

FIG. 12 is a diagram of a chip set that can be used to implement an embodiment of the processes described herein; and

FIG. 13 is a diagram of a terminal that can be used to implement an embodiment of the processes described herein.

### DESCRIPTION OF SOME EMBODIMENTS

Examples of a method, apparatus, and computer program for providing place category prediction are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

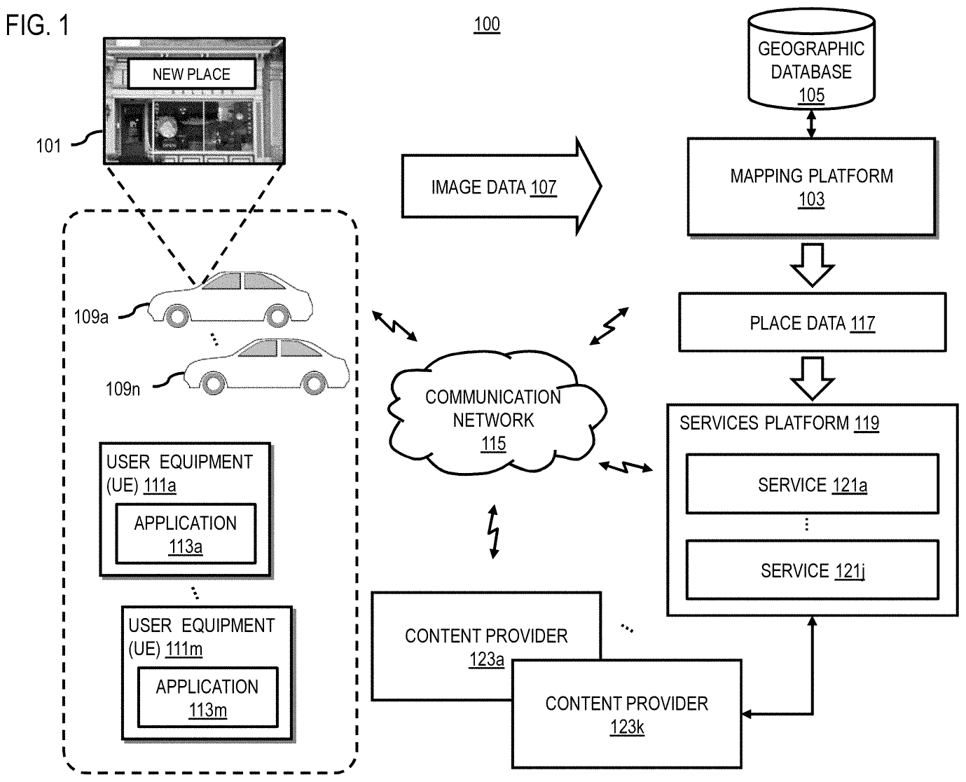

FIG. 1 is a diagram of a system 100 capable of providing place category prediction, according to one embodiment. Historically, the category of newly discovered place 101 (e.g., a point of interest (POI) such as a store) has been predicted by a rule-based application for deciding the category of the newly discovered place 101 or set by a default category. Recently, a machine learning model (e.g., configured within a mapping platform 103) which utilizes only the place's name as an input for the prediction). This is because newly discovered places (e.g., place 101) generally have limited information about themselves to convey their correct category types. As used herein, a category describes one or more characteristics or attributes of the place 101. In one embodiment, the categories can be any grouping defined by a mapping service provider for describing any place or map feature stored in a geographic database 105 or equivalent digital map data. Examples of categories include but are not limited to “Eat and drink” indicating places that serve food and drinks, “Going out entertainment” indicating places that provide entertainment for an evening out, “Shopping” indicating places where customers can shop, “Business and Services” indicating places that provide office services, and/or the like. In one embodiment, the categories can be hierarchical such that a category at one hierarchy level can be branched into one or more subcategories. For example, the “Eat and drink” category can have subcategories such as “restaurants,” “food courts,” etc. These subcategories can also have further subcategories, and so on (e.g., “restaurant” subcategory can be further broken down by cuisine such as “French restaurant,” “Italian restaurant,” etc.). It is noted that the categories and subcategories described above are provided by way of illustration and not as limitations. It is contemplated that the embodiments described herein are applicable to any set of categories or category structure that can be used to describe or characterize places or map features of the geographic database 105.

Historically, when new places (e.g., place 101) are discovered and are about to be stored in the place repository (e.g., the geographic database 105 of the mapping platform 103), the information that is known about those place may be relatively sparse and include only the places' names, geo-coordinates, and/or phone numbers. This is because, in many cases, new places are discovered using images (e.g., image data 107) captured by vehicles 109a-109n (also collectively referred to as vehicles 109) and/or user equipment (UE) devices 111a-111m (also collectively referred to as UEs 111 such as but not limited to camera-equipped smartphones or equivalent mobile devices). For example, the vehicles 109 and/or UEs 111 can execute respective applications 113a-113m (also collectively referred to as applications 113) to capture images using respective imaging sensors of the devices.

In one embodiment, the image data 107 (e.g., images or new place 101) are transmitted to the mapping platform 103 over a communication network 115 for processing using a computer vision system (e.g., a deep vision platform that uses machine learning to identify places). In this example, the image of new place 101 may indicate the presence of a store front at the geo-coordinates at which the image was captured. The computer vision system of the mapping platform 103 may also extract the name of the place 101 from the image (e.g., a sign indicating “New Place” as the name of place 101). The mapping platform 103 can further search a business directory based on the extracted place name to determine a phone number, thereby providing the traditional information of place name, geo-coordinate, and phone number for the place 101.

However, place names are often insufficient information to predict the correct categories. Besides the place names might mislead the traditional neural network's training and prediction procedure. This is because, the name of a business often is not a good indicator of a category of the business. In other words, if newly discovered place names do not contain words that imply enough about the category, the prediction results have lower prediction scores. In addition, it has been observed that the prediction score is not stable throughout all category types. The accuracy of place categories predicted from place name alone as traditionally done often result in category matching scores that fluctuate depending on the category types. Accordingly, service providers face significantly technical challenges to predicting the place category or newly discovered places with accuracy.

To address these technical challenges, the system 100 of FIG. 1 introduces a capability to use a Graph Convolutional Network-based prediction model that can overcome the lack of information about place to generate more accurate place category predictions (e.g., place category data 117). In one embodiment, the system 100 provides for place category prediction by firstly, constructing a place graph representing the places (e.g., as place nodes) and connections (e.g., as edges) indicating the neighboring relationships of the places. The place graph is the input of a Graph Convolutional Network to learn the encoding of each place. Once the system 100 trains the place graph with the model, the system 100 has the encoding of all places in the graph. The system 100 can then see or retrieve the encoding and category (which is also called the label of node) of the place node. When the system 100 identifies a newly discovered place (or any other designated place), they system 100 provides the features of this newly discovered place (e.g., a place name or other attribute) in the trained model (e.g., Graph Convolutional Network trained on the place graph) as an input. The system 100 can then get the predicted label (e.g., which is predicted category) as an output.

In other words, in one embodiment, the system 100 utilizes each target place's neighborhood information (e.g., the known categories of the neighboring places) in the places graph to encode the Graph Convolutional Network model with the neighboring information. This trained Graph Convolutional Network model is implicitly incorporating the neighborhood information which is latent information in the raw input data (e.g., the place graph) and can then be used to make a place category prediction of a target or designated place. In one embodiment, the predictive model can also infer the demographic information around the target place and apply the demographic knowledge in final category selection stage of place category prediction to increase the prediction accuracy.

In other words, the embodiments described herein for place category prediction discovers latent information that can improve the place category prediction capability of the system 100 (e.g., by increasing place category prediction accuracy). In one embodiment, the latent information about a place includes the place's neighborhood information and the relationship of the neighborhood information with the target or new place (e.g., whether the neighborhood information is compatible/similar to the target place) for prediction. In one embodiment, the system 100 can extract the neighborhood information from the digital map data by performing a spatial query using the geo-coordinates of the new place to identify known neighboring places and represent the neighboring places as a graph.

In one embodiment, the neighborhood (e.g., comprising other neighboring places) is identified during the constructing of the place graph. The node in the place graph indicates a place, and the connected places are adjacent nodes that are neighboring places in the real world. In one embodiment, the system 100 can apply differentiated message propagation methods to encode of each node in the graph as opposed to using just one message propagation method. The use of differentiated message propagation methods enables the system 100 to advantageously adapt the message propagation method or corresponding aggregation functions to the relationship between each node and its neighbors to embed the neighborhood information to the Graph Convolution Network for generating place category predictions (e.g., place category data 117).

The place category predictions can then be provided as an output to any service, device, component, system, etc. For example, the place category data 117 can be transmitted to a services platform 119 and/or any of the services 121a-121j (also collectively referred to as services 121) or one or more content providers 123a-123k (also collectively referred to as content providers 123) that can make use of the place category predictions. By way of example, the services 121 and/or content providers 123 can include but are not limited to mapping services, navigation services, media services, weather services, and/or any other location-based services or content.

It is noted that although the various embodiments are described with respect to predicting the categories of places, it is contemplated that the embodiments are also applicable to predicting the categories of any map feature detected in the real world and represented in the digital map data (e.g., the geographic database 105). For example, the category of map features such as but not limited to road segments, terrain features, political boundaries, and/or the like can also be predicted according to the embodiments described herein.

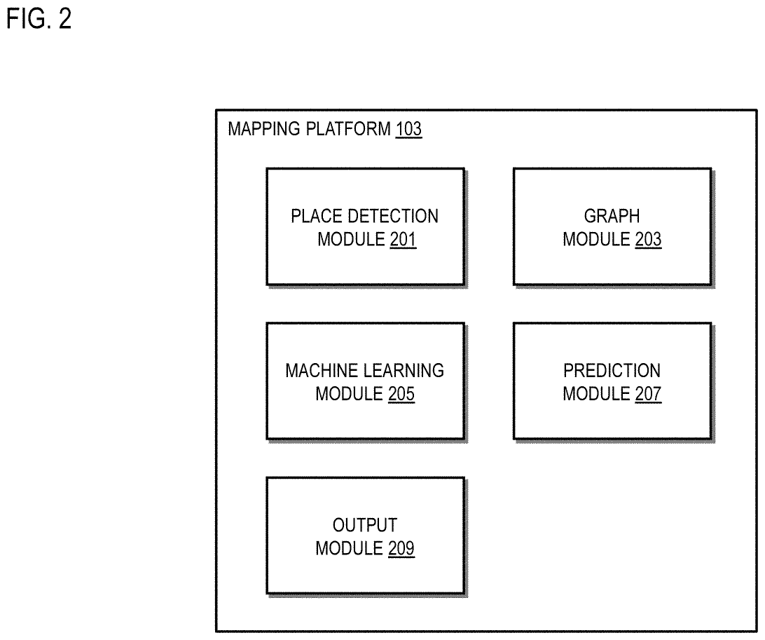

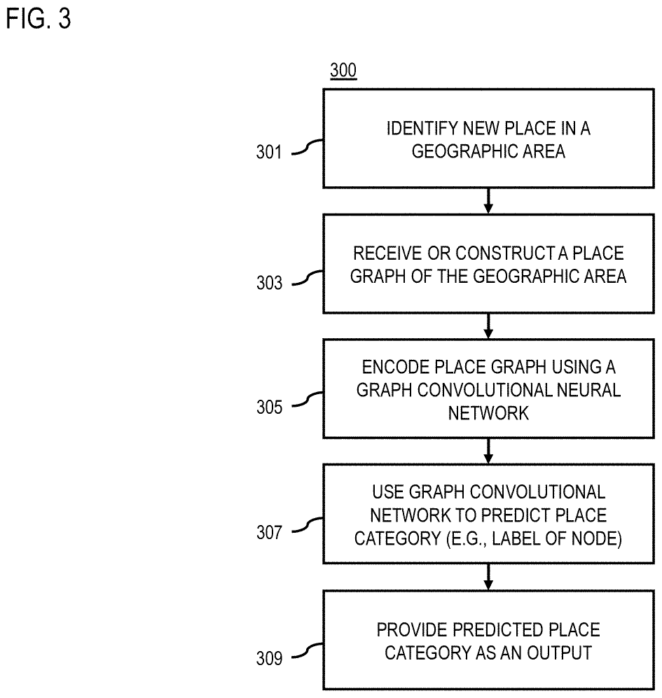

In one embodiment, as shown in FIG. 2, the mapping platform 103 of the system 100 includes one or more components for providing place category prediction based on latent neighborhood information according to the various embodiments described herein. It is contemplated that the functions of the components of the mapping platform 103 may be combined or performed by other components of equivalent functionality. As shown, in one embodiment, the mapping platform 103 includes a place detection module 201, a graph module 203, a machine learning module 205, a prediction module 207, and an output module 209. The above presented modules and components of the mapping platform 103 can be implemented in hardware, firmware, software, or a combination thereof. Though depicted as a separate entity in FIG. 1, it is contemplated that the mapping platform 103 may be implemented as a module of any of the components of the system 100 (e.g., a component of the services platform 119, services 121, content providers 123, vehicles 109, UEs 111, and/or the like). In another embodiment, one or more of the modules 201-209 may be implemented as a cloud-based service, local service, native application, or combination thereof. The functions of the mapping platform 103 and modules 201-209 are discussed with respect to FIGS. 3-10 below.

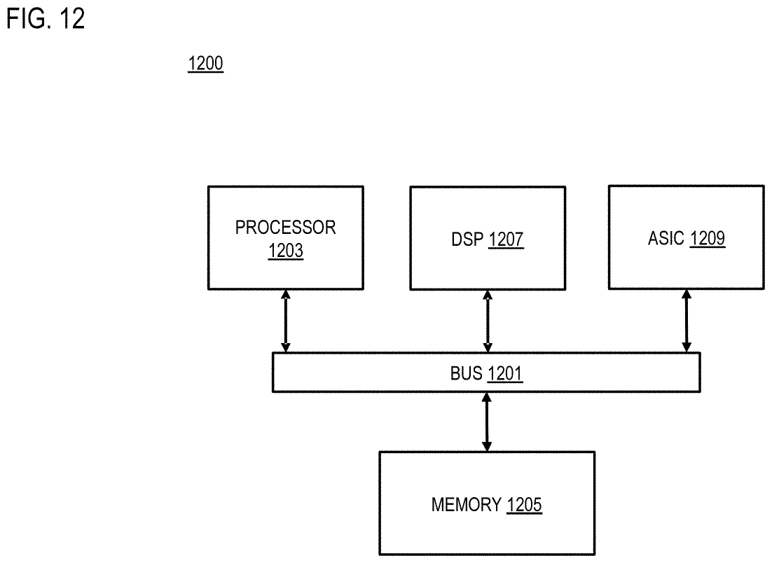

FIG. 3 is a flowchart of a process 300 for providing place category prediction, according to one embodiment. In various embodiments, the mapping platform 103 and/or any of the modules 201-209 may perform one or more portions of the process 300 and may be implemented in, for instance, a chip set including a processor and a memory as shown in FIG. 12. As such, the data mapping platform 103 and/or any of the modules 201-209 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In step 301, the place detection module 201 identifies a place located in a geographic area. As described above, the place detection module 201 can discover a new or updated place by processing street level imagery using a computer vision system to identify places have been established or updated since the last update to the geographic database 105. A new place, for instance, refers to a place that has not been previously recorded in the geographic database 105; and an update place refers to place with detected attributes (e.g., place name) that has changed with respect to a corresponding place or POI record in the geographic database 105. It is also noted that the use of a computer vision system for discovering new places is provided by way of illustration and not as a limitation. It is contemplated that any means known in the art to detect a new or updated place can be used to identify a place according to the embodiments described herein. For example, places can be detected by analyzing probe data to discover stay points, can be specified by manual entry, or any other equivalent process.

In step 303, after a target place is identified, the graph module 203 receives (e.g., from any other component of the system 100) or otherwise constructs a place graph comprising the place as a place node and one or more neighbor nodes representing one or more neighboring places in the geographic area. In other words, the embodiments of place category prediction task described herein is based on the place graph. In one embodiment, the place graph can represent the places that have already been mapped and/or categorize in a geographic area (e.g., the mapped places of the geographic database 105. For example, the geographic area can be any area encompassing a target/designated place of interest such as a newly discovered place that is to be categorized. Accordingly, the place graph, for instance, comprises one or more place nodes representing one or more places in the geographic area and one or more edges representing one or more neighboring relationships between the one or more places.

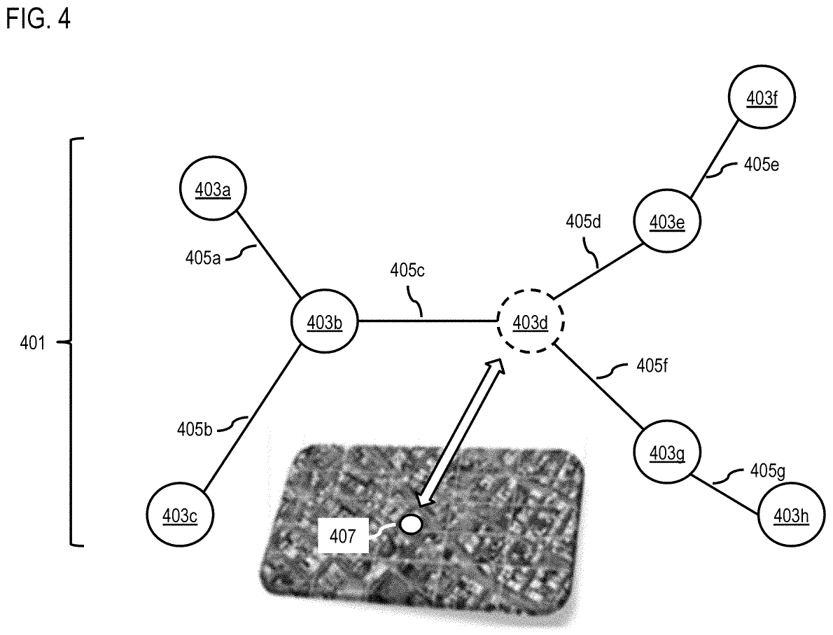

As shown in the example of FIG. 4, a place graph 401 consists of place nodes 403a-403h (also collectively referred to as place nodes 403) and edges 405a-405g (also collectively referred to as edges 405) between the place nodes 403. In this example, place node 403d (indicated by a dashed circle) represents a newly discovered place 407 in the real world. The place nodes 403a-403c and 403e-403h represent the neighboring nodes of the new place node 403d.

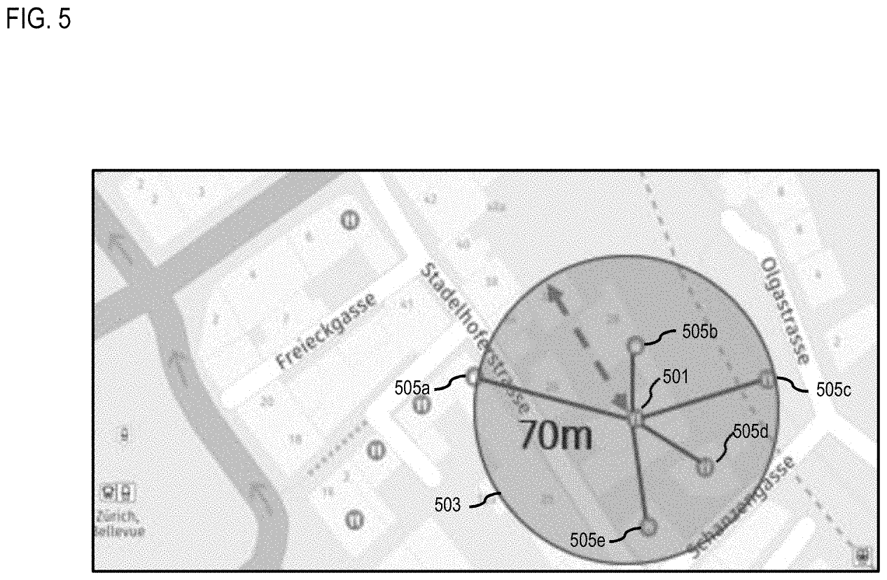

In one embodiment, the connections or edges 405 between neighboring place nodes 403 are determined based on proximity. For instance, any places within a threshold proximity or distance are designated as neighbors, and therefore, the place graph represents the neighbor relationship or connection as an edge. In the example of FIG. 5, a new place 501 is determined in a geographic area. The graph module 203 can designate a radius (e.g., a 70 m radius) that defines a circle 503 delineating a proximity threshold for determining what other real-world places are neighbors to the new place 501. As shown, places 505a-505e are located within or touching the circle 503 and are thus designated as neighbors to the new place 501. Accordingly, respective edges or connections can be created between the new place 501 and each of its neighboring places 505a-505e.

In one embodiment, the place graph can be constructed for any designated geographic area to represent the places known or stored in the geographic database 105. In this way, a place graph can pre-created for any designated geographic area. When a new place is selected or a target place otherwise designated, the new or target place can be inserted into the pre-constructed graph to create new connections or edges to the new or target places as needed based on the proximity threshold.

In step 305, machine learning module 205 encodes the place graph using or by a machine learning model such as, but not limited to, a graph convolutional network or equivalent. The graph convolutional network, for instance, is trained using at least one message propagation method of a plurality of differentiated message propagation methods. More specifically, in one embodiment, the place graph can be represented as an adjacency matrix. The machine learning module 205 can then train the machine learning model the place graph represented as the adjacency matrix. By way of example, in an adjacency matrix, the rows are places, and the columns are connected neighboring places. The machine learning module 205, for instance, can take into account the adjacency matrix of the place graph in the differentiated message propagation method (e.g., a forward propagation equation) in addition to the node features (e.g., the neighbor or latent information used an input features of the Graph Convolutional Network. A Graph Convolutional Network encodes the place node using the node's own information and the passed information about neighboring place nodes. This way of encoding is possible since the model utilizes the structure of place graph (e.g., the relationship between a node and neighboring nodes) as equivalent to adjacent neural network layers in an artificial neural network model. In this way, information or messages propagate through the Graph Convolutional Network based on the neighboring relationship of the places corresponding to the nodes of the network.

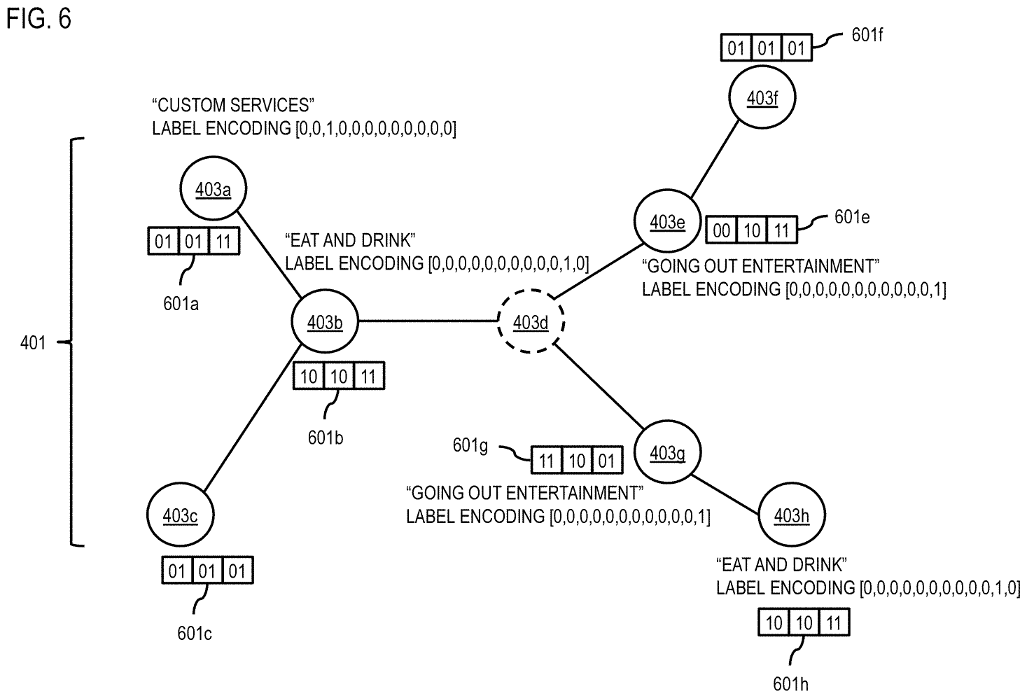

In one embodiment, the graph convolutional network encodes each node of graph to contain its own information (e.g., in vector form or equivalent). In particular, the encoded information contains information (e.g., place name, geo-coordinates, category information if available) of node itself, together with its neighboring nodes information. FIG. 6 is a diagram illustrating an example of place encoding vectors, according to one embodiment. The example of FIG. 6 uses the place graph 401 of FIG. 4 and supplements some of the neighboring nodes with place category labels. As shown, place node 403a has a place category of “Custom services” represented by label encoding [0,0,1,0,0,0,0,0,0,0,0,0]; place node 403b has a place category of “Eat and drink” represented by label encoding [0,0,0,0,0,0,0,0,0,0,1,0]; place node 403e has a place category of “Going out entertainment” represented by label encoding [0,0,0,0,0,0,0,0,0,0,0,1]; place node 403g has a place category of “Going out entertainment” represented by label encoding [0,0,0,0,0,0,0,0,0,0,0,1]; and place node 403h has a place category of “Eat and drink” represented by label encoding [0,0,0,0,0,0,0,0,0,0,1,0]. This place category information along with other node information (e.g., place name, geo-coordinates, etc.) can be encoded as a vector for one or more nodes of the place graph. In the example of FIG. 6, the place category for new place node 403d is to be predicted. Accordingly, information from its neighboring nodes 403a-403c and 403e-403h can be encoded as respective vectors 601a-601c and 601e-601h to serve as input features to the Graph Convolutional Network. By way of example, the input feature representing information such as the place name (or any other place attribute) can be encoded as a 768-dimensional vector by BERT or equivalent transformation.

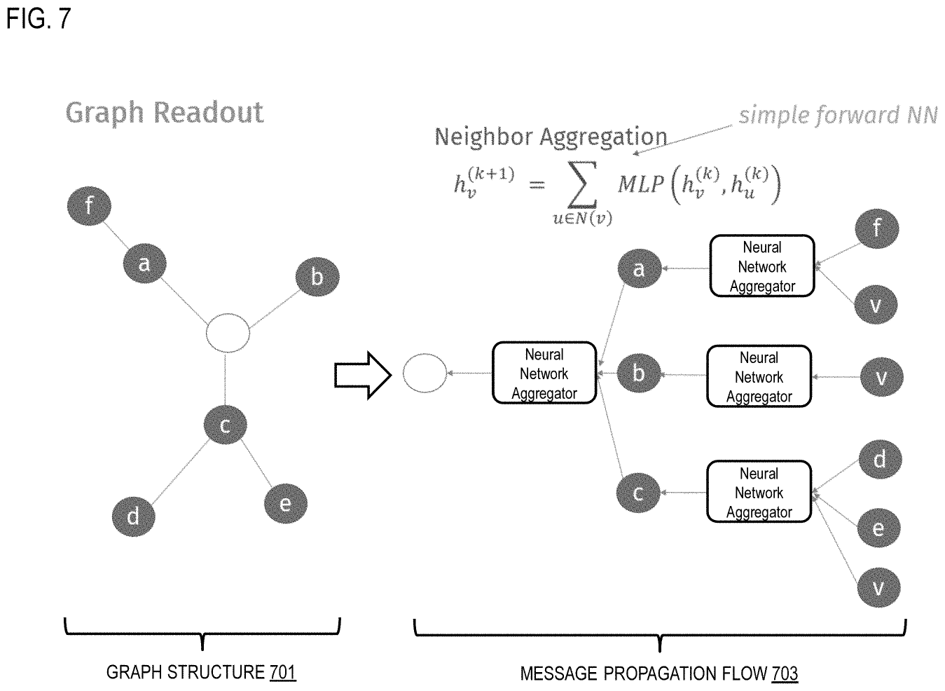

In one embodiment, in the Graph Convolutional Network training stage, a message propagation method does the encoding task for all nodes (e.g., the place nodes 403 of the FIG. 6). FIG. 7 illustrates how a message from one node of a place graph can be propagated to adjacent connected nodes when encoded in a Graph Convolutional Network according to the embodiments described herein. As shown, a graph structure 701 represents a new place as a white circle with no label and the known place nodes neighboring the new place node respectively as dark circles labeled “a” through “f” respectively. In one embodiment, the graph structure 701 can be read out to a neural network structure and more specifically a Graph Convolutional Network where the place nodes are arranged in layers corresponding the adjacency of the nodes in the graph. The message propagation flow 703 indicates how messages flow through the layers of the Graph Convolutional Network. The message propagation flow 703 illustrates the new place node on the left side which is feed messages from nodes a, b, and c through a neural network aggregator (e.g., neighbor aggregation through simple feed forward neural network aggregation). Each of the immediate neighbor a, b, and c respectively receive aggregated messages from their respective neighbors.

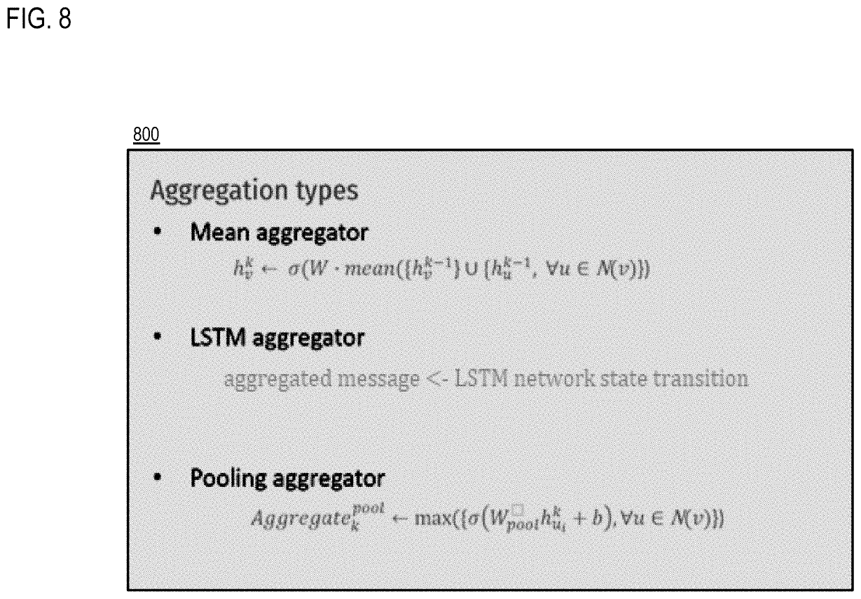

In one embodiment, the way that messages are propagated to each other in the encoded Graph Convolutional Network is same way as values in neural network are transferred from one layer to the other by either linear or non-linear transition functions. FIG. 8 illustrates examples of transition or aggregation functions in table 800. These aggregation types include but are not limited to a mean aggregator, a long short-term memory (LSTM) aggregator, a pooling aggregator (e.g., maximum or minimum pooling aggregator), or any other equivalent aggregator. In other words, the plurality of differentiated message propagation methods available to the machine learning module 205 can be respectively associated with different aggregation functions.

In one embodiment, the Graph Convolutional Network can apply one message propagation method for all nodes in a graph. However, in other embodiments, the Graph Convolutional Network differentiate the usage of message propagation methods per node. The application of different message propagation methods per node depends, for instance, on the relationship between a place (node) and neighboring places (connected nodes). Based on the determined relationship, different aggregation functions can be used.

The message propagation method can be chosen by determining the compatibility of categories between a node and its neighbors. In other words, the machine learning module 205 can select a message propagation method to use from among a plurality of differentiated message propagation methods based on the compatibility. Differentiated message propagation method refer, for instance, to the machine learning module 205's capability to use different message propagation methods for different nodes of the place graph or Graph Convolutional Network. Accordingly, the message propagation method can be selected on a node-by-node basis.

By way of example, any metric or process for compatibility of categories can be used. For instance, if categories of neighboring places are similar (e.g., semantically similar or similar according to designated heuristics or rules), then a mean aggregator can be used. In other words, the machine learning module 205 can determine that the place categories of the one or more neighboring nodes, the place, or a combination thereof have a similarity above a threshold value (e.g., are compatible), and then select the at least one message propagation method from the plurality of differentiated message propagation methods that uses a mean aggregator. In cases when the category of a node to encodes is not compatible (e.g., semantically not compatible or not compatible according to designated heuristics or rules) with neighboring places' categories, the machine learning module 205 can use minimum or maximum pooling aggregator. Therefore, the Graph Network propagates minimum or maximum messages from neighbor nodes to node that the machine learning module 205 is in the process of encoding. In other words, the machine learning module 205 can determine that the place categories of the one or more neighboring nodes, the place, or a combination thereof have a similarity below a threshold value (e.g., are not compatible), and then select the at least one message propagation method from the plurality of differentiated message propagation methods that uses a minimum pooling aggregator or a maximum pooling aggregator. With this proposed approach, the machine learning module 205 can encode each node with more realistic information about its neighboring nodes.

In step 307, the prediction module 207 can use the graph convolutional network with the encoded place graph to predict a category of the place. For example, once the machine learning module 205 encodes the place graph using the Graph Convolutional Network (e.g., during a training process of the Graph Convolutional Network based on the place graph data), the prediction module 207 can predict the place category (e.g., the label) of a place node in graph for which the category is not yet known.

Typically, the prediction model (e.g., the Graph Convolutional network) calculates the probabilities of all possible place categories and then the category or label with highest probability is selected as a predicted category for given place (node). In one embodiment, at this selection stage, the prediction module 207 can incorporate the demographic information that can be inferred or otherwise determined from neighboring places categories. For example, the demographics can be inferred or determined using a lookup table as illustrated in Table 1 below:

TABLE 1

| PLACE CATEGORY | DEMOGRAPHICS |
|---|---|
| Office Building | Office Workers |
| University Hospital | Health Care Workers |
| Park | Joggers, Residences, Tourists |
| Restaurant | Customers, Restaurant Staff |

Since the prediction module 207 knows or can determine the target place's neighboring places and their categories, the prediction module 207 can infer the possible demographic characteristics of the neighborhood of target place (e.g., using Table 1 above or any other equivalent means). In other words, the prediction module 207 can determine demographic information associated with the place, the one or more neighboring places, the geographic area, or a combination thereof. The predicted category can then be based on the demographic information.

In other embodiments, the prediction module 207 can determine the compatibility of the predicted category with the demographic information and then revise the predicted category based on the demographic information. For example, using the inferred demographic information, we can give positive or negative weights on target place's category probabilities. For instance, the predicted category is not compatible with major demographic property, then the prediction module 207 can penalize on the probability of a given place category by giving negative weights. In this way, the prediction module 207 determines a weighting of the predicted category based on a level of the compatibility or similarity of the predicted category and the demographic information (e.g., office workers may not be compatible with park during business hours, tourists may not be compatible with a hospital, etc.). With the final demographic compatibility matching procedure, the prediction module 207 can revise the category prediction more realistically and ultimately it helps to improve the category prediction.

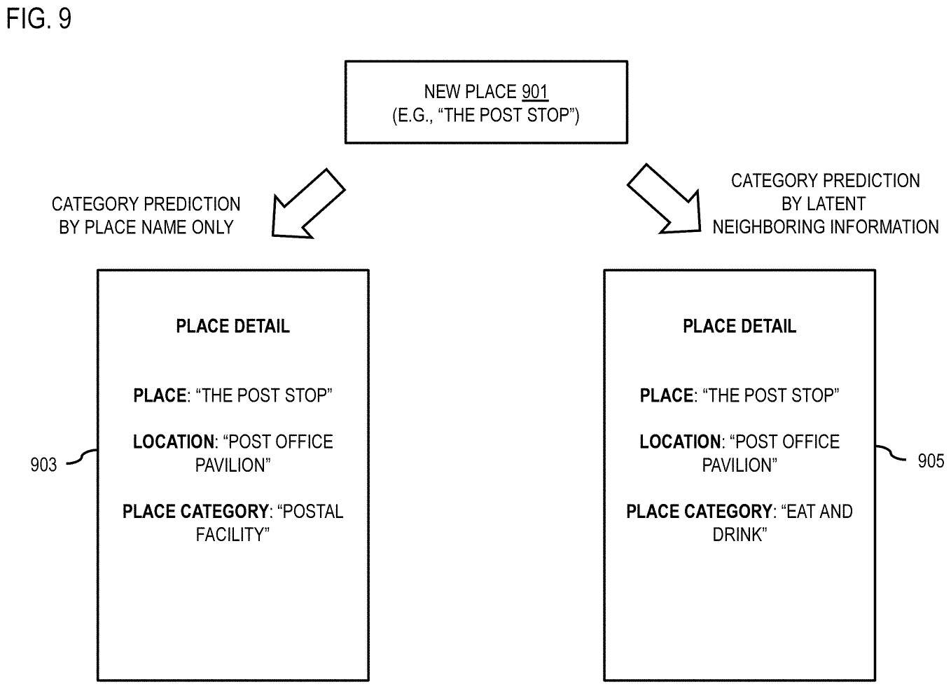

In step 309, providing the predicted category of the place as an output. In one embodiment, the predicted place category output can be presented in a mapping user interface as illustrated in FIG. 9. More specifically, FIG. 9 illustrates an example in which place category prediction using name only can provide for a different prediction output for presentation than place category prediction according to the embodiments described herein. In the illustrated example, a new place 901 is detected with a place name of “The Post Stop” for which a place category is to be predicted. Assume in this example, that the ground truth place category is “Eat and Drink” because “The Post Stop” is actually a restaurant/bar. Under a traditional place category prediction approach that relies on the place name only, the place category might be incorrectly predicted to be a postal facility. Thus, the traditional approach may result in presenting a mapping user interface 903 that indicates the place detail for the new place 901 and lists “Postal Facility” incorrectly as its place category.

In contrast, using the place category prediction process according to the embodiments described herein can potentially result in a more accurate place category prediction by taking into account information from neighboring places. In this case, the “Post Office Pavilion” is a shopping mall that has been renovated from a former postal facility and many of the shops and restaurants in the mall share a postal theme. By determining neighboring places to the new place 901 and their associated categories, the system 100 can use the Graph Convolutional Network encoded with a corresponding place graph according the embodiments described to make a more accurate prediction based on the neighboring information. In the illustrated example, the system 100 correctly predicts that the new place 101 is in the “Eat and Drink” category because the neighboring place categories are more compatible or similar to the predicted category. Accordingly, the system 100 can present a mapping user interface 905 that includes an accurate place category, thereby improving the user experience with the mapping application providing the user interface 905.

Returning to FIG. 1, as shown, the system 100 includes a mapping platform 103 for providing place category prediction using latent neighbor information according to the various embodiments described herein. In one embodiment, the mapping platform 103 includes or is otherwise associated with one or more machine learning models (e.g., neural networks such as a Graph Convolutional Network or other equivalent network in which spatial relationships between places can be encoded) for place category prediction. The machine learning models can also be used as part of a computer vision system for detecting new or updated places through image analysis.

In one embodiment, the mapping platform 103 has connectivity over the communication network 115 to the services platform 119 that provides one or more services 121 that can place category data 117 (e.g., place category predictions) to perform one or more functions. By way of example, the services 121 may be third party services and include but is not limited to mapping services, navigation services, travel planning services, notification services, social networking services, content (e.g., audio, video, images, etc.) provisioning services, application services, storage services, contextual information determination services, location based services, information based services (e.g., weather, news, etc.), etc. In one embodiment, the services 121 uses the output of the mapping platform 103 (e.g., place category predictions) to provide services 121 such as navigation, mapping, other location-based services, etc. to the vehicles 109, UEs 111, and/or applications 113 executing on the UEs 111.

In one embodiment, the mapping platform 103 may be a platform with multiple interconnected components. The mapping platform 103 may include multiple servers, intelligent networking devices, computing devices, components, and corresponding software for providing place category prediction according to the various embodiments described herein. In addition, it is noted that the mapping platform 103 may be a separate entity of the system 100, a part of the one or more services 121, a part of the services platform 119, or included within components of the vehicles 109 and/or UEs 111.

In one embodiment, content providers 123 may provide content or data (e.g., including geographic data, place category data 117, etc.) to the geographic database 105, the mapping platform 103, the services platform 119, the services 121, the vehicles 109, the UEs 111, and/or the applications 113 executing on the UEs 111. The content provided may be any type of content, such as machine learning models, place category data 117, map embeddings, map content, textual content, audio content, video content, image content, etc. In one embodiment, the content providers 123 may provide content that may aid in performing place category prediction according to the various embodiments described herein. In one embodiment, the content providers 123 may also store content associated with the geographic database 105, mapping platform 103, services platform 119, services 121, and/or any other component of the system 100. In another embodiment, the content providers 123 may manage access to a central repository of data, and offer a consistent, standard interface to data, such as a repository of the geographic database 105.

In one embodiment, the vehicles 109 and/or UEs 111 may execute software applications 113 to detect map features/objects and/or make map-related predictions (e.g., place category prediction) according the embodiments described herein. By way of example, the applications 113 may also be any type of application that is executable on the vehicles 109 and/or UEs 111, such as autonomous driving applications, mapping applications, location-based service applications, navigation applications, device control applications, content provisioning services, camera/imaging application, media player applications, social networking applications, calendar applications, and the like. In one embodiment, the applications 113 may act as a client for the mapping platform 103 and perform one or more functions associated with providing place category prediction alone or in combination with the mapping platform 103.

By way of example, the vehicles 109 and/or UEs 111 is or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the vehicles 109 and/or UEs 111 can support any type of interface to the user (such as “wearable” circuitry, etc.). In one embodiment, the vehicles 109 and/or UEs 111 may be associated with or be a component of a vehicle or any other device.

In one embodiment, the vehicles 109 and/or UEs 111 are configured with various sensors for generating or collecting environmental image data (e.g., for processing by the mapping platform 103), related geographic data, etc. In one embodiment, the sensed data represent sensor data associated with a geographic location or coordinates at which the sensor data was collected, and the polyline or polygonal representations of detected objects of interest derived therefrom. By way of example, the sensors may include a global positioning sensor for gathering location data (e.g., GPS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the vehicles 109 and/or UEs 111 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the vehicles 109 and/or UEs 111 may detect the relative distance of the device or vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the vehicles 109 and/or UEs 111 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 115 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth® network, Internet Protocol (IP) data casting, satellite, mobile ad-hoc network (MANET), and the like, or any combination thereof.

By way of example, the mapping platform 103, services platform 119, services 121, vehicles 109 and/or UEs 111, and/or content providers 123 communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

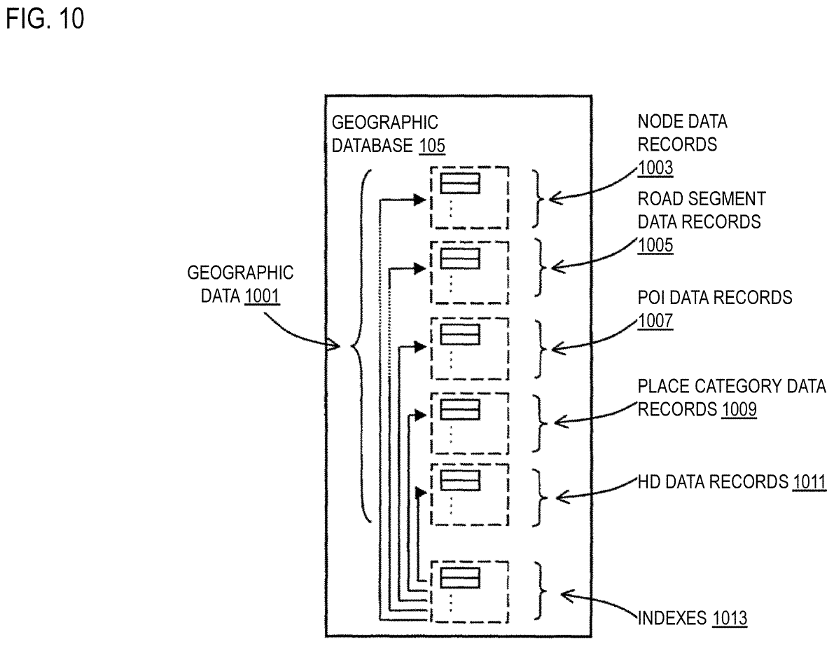

FIG. 10 is a diagram of a geographic database, according to one embodiment. In one embodiment, the geographic database 105 includes geographic data 1001 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 1001. In one embodiment, the geographic database 105 include high definition (HD) mapping data that provide centimeter-level or better accuracy of map features. For example, the geographic database 105 can be based on Light Detection and Ranging (LiDAR) or equivalent technology to collect billions of 3D points and model road surfaces and other map features down to the number lanes and their widths. In one embodiment, the HD mapping data (e.g., HD data records 1011) capture and store details such as the slope and curvature of the road, lane markings, roadside objects such as sign posts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 105.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 105 follows certain conventions. For example, links do not cross themselves and do not cross each other except at a node. Also, there are no duplicated shape points, nodes, or links. Two links that connect each other have a common node. In the geographic database 105, overlapping geographic features are represented by overlapping polygons. When polygons overlap, the boundary of one polygon crosses the boundary of the other polygon. In the geographic database 105, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 105 includes node data records 1003, road segment or link data records 1005, POI data records 1007, place category data records 1009, HD mapping data records 1011, and indexes 1013, for example. More, fewer or different data records can be provided. In one embodiment, additional data records (not shown) can include cartographic (“carto”) data records, routing data, and maneuver data. In one embodiment, the indexes 1013 may improve the speed of data retrieval operations in the geographic database 105. In one embodiment, the indexes 1013 may be used to quickly locate data without having to search every row in the geographic database 105 every time it is accessed. For example, in one embodiment, the indexes 1013 can be a spatial index of the polygon points associated with stored feature polygons.

In exemplary embodiments, the road segment data records 1005 are links or segments representing roads, streets, or paths, as can be used in the calculated route or recorded route information for determination of one or more personalized routes. The node data records 1003 are end points (for example, representing intersections or an end of a road) corresponding to the respective links or segments of the road segment data records 1005. The road link data records 1005 and the node data records 1003 represent a road network, such as used by vehicles, cars, and/or other entities. Alternatively, the geographic database 105 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 105 can include data about the POIs and their respective locations in the POI data records 1007. The geographic database 105 can also include data about places, such as cities, towns, or other communities, and other geographic features, such as bodies of water, mountain ranges, etc. Such place or feature data can be part of the POI data records 1007 or can be associated with POIs or POI data records 1007 (such as a data point used for displaying or representing a position of a city).

In one embodiment, the geographic database 105 can also include place category data records 1009 for storing place category predictions, place graphs, machine learning model parameters, and/or any other related data that is used or generated according to the embodiments described herein. By way of example, the place category data records 1009 can be associated with one or more of the node records 1003, road segment records 1005, and/or POI data records 1007 to associate the place category predictions with specific places, POIs, geographic areas, and/or other map features. In this way, the place category data records 1009 can also be associated with the characteristics or metadata of the corresponding records 1003, 1005, and/or 1007.

In one embodiment, as discussed above, the HD mapping data records 1011 model road surfaces and other map features to centimeter-level or better accuracy. The HD mapping data records 1011 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 1011 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 1011 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1011.

In one embodiment, the HD mapping data records 1011 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 105 can be maintained by the content provider 123 in association with the services platform 119 (e.g., a map developer). The map developer can collect geographic data to generate and enhance the geographic database 105. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 105 can be a master geographic database stored in a format that facilitates updating, maintenance, and development. For example, the master geographic database or data in the master geographic database can be in an Oracle spatial format or other format (e.g., that can accommodate multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by a vehicles 109 and/or UEs 111. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing place category prediction may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

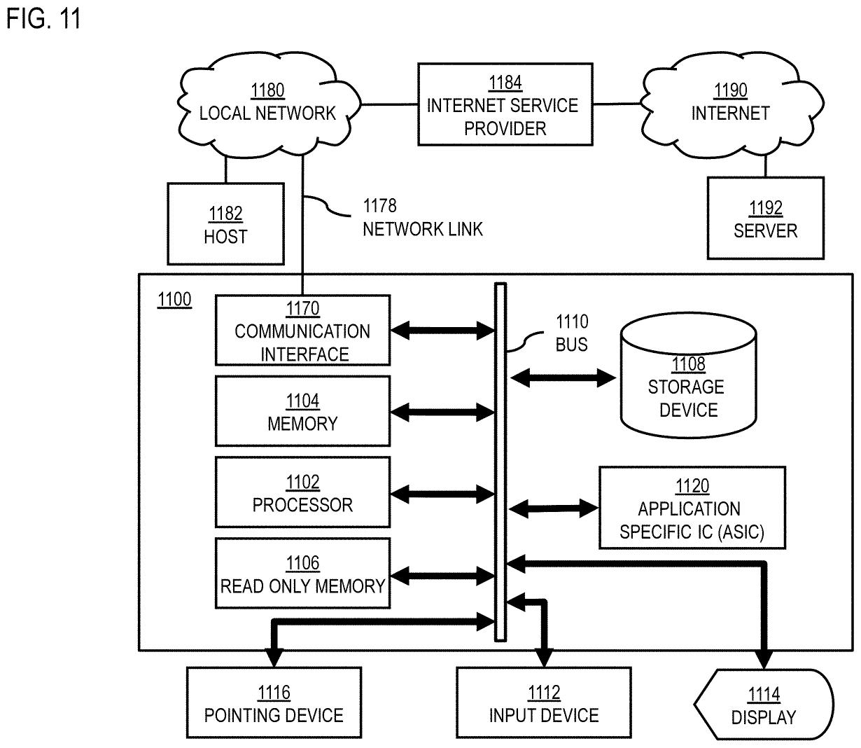

FIG. 11 illustrates a computer system 1100 upon which an embodiment of the invention may be implemented. Computer system 1100 is programmed (e.g., via computer program code or instructions) to provide place category prediction as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to providing place category prediction. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RANI) or other dynamic storage device, stores information including processor instructions for providing place category prediction. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for providing place category prediction, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners, and external disks. In general, the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic, or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 115 for providing place category prediction.

The term computer-readable medium is used herein to refer to any medium that participates in providing information to processor 1102, including instructions for execution. Such a medium may take many forms, including, but not limited to, non-volatile media, volatile media, and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system can be deployed in various configurations within other computer systems, e.g., host 1182 and server 1192.

FIG. 12 illustrates a chip set 1200 upon which an embodiment of the invention may be implemented. Chip set 1200 is programmed to provide place category prediction as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to provide place category prediction. The memory 1205 also stores the data associated with or generated by the execution of the inventive steps.

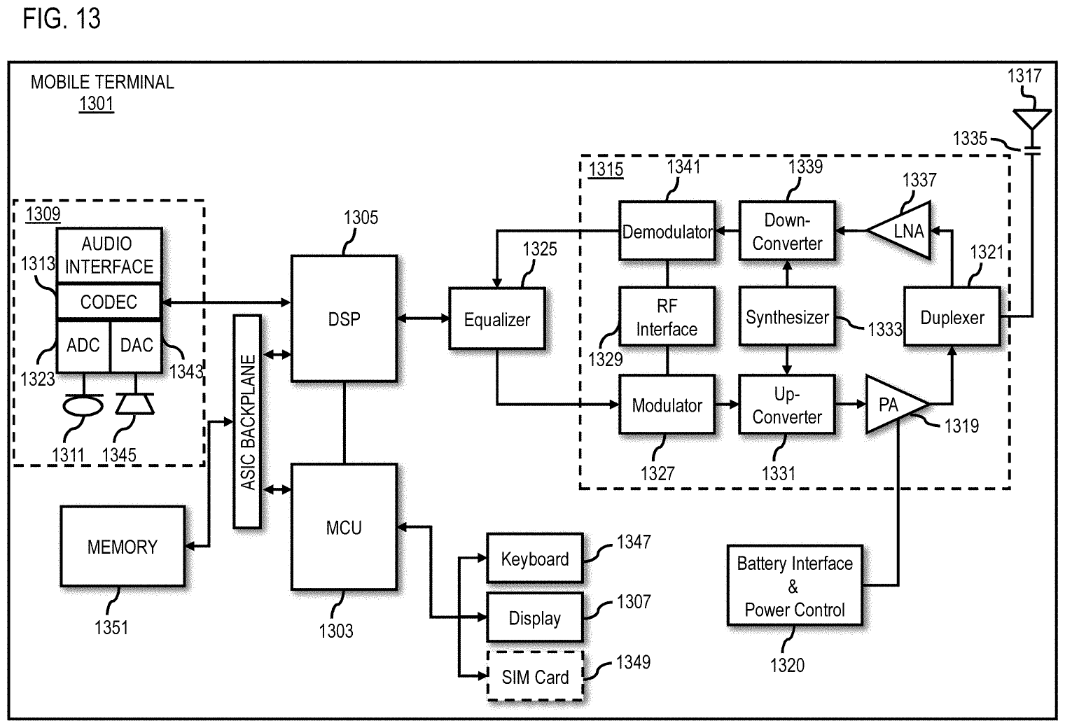

FIG. 13 is a diagram of exemplary components of a mobile terminal 1301 (e.g., a vehicle 109 and/or UE 111 or component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions that offer automatic contact matching. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile station 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303—which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile station 1301 to provide place category prediction. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile station 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1351 may be, but not limited to, a single memory, CD, DVD, ROM, RAM, EEPROM, optical storage, or any other non-volatile or non-transitory storage medium capable of storing digital data.

An optionally incorporated SIM card 1349 carries, for instance, important information, such as the cellular phone number, the carrier supplying service, subscription details, and security information. The SIM card 1349 serves primarily to identify the mobile station 1301 on a radio network. The card 1349 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method comprising:
identifying a designated place located in a geographic area;
receiving a place graph comprising one or more place nodes representing one or more places in the geographic area and one or more edges representing one or more neighboring relationships between the one or more places;
encoding the place graph using a graph convolutional network, wherein the graph convolutional network is trained using at least one message propagation method of a plurality of differentiated message propagation methods; and
using the graph convolutional network with the encoded place graph to predict a category of the designated place; and
providing the predicted category of the designated place as an output.

2. The method of claim 1, further comprising:
determining demographic information associated with the designated place, one or more neighboring places of the designated place, the geographic area, or a combination thereof,
wherein the predicted category is further based on the demographic information.

3. The method of claim 2, further comprising:
determining a compatibility of the predicted category with the demographic information; and
revising the predicted category based on the compatibility.

4. The method of claim 3, further comprising:
determining a weighting of the predicted category based on a level of the compatibility of the predicted category and the demographic information.

5. The method of claim 1, further comprising:
encoding information of the designated place and one or more neighboring places in a vector representing the place node.

6. The method of claim 1, wherein the encoding of the place graph using the graph convolutional network is performed on the place graph represented as the adjacency matrix.

7. The method of claim 1, further comprising:
determining a compatibility of place categories of the one or more neighboring nodes, the place, or a combination thereof; and
selecting the at least one message propagation method from the plurality of differentiated message propagation methods based on the compatibility.

8. The method of claim 1, wherein the plurality of differentiated message propagation methods is respectively associated with different aggregation functions.

9. The method of claim 1, further comprising:
determining that the place categories of the one or more neighboring nodes, the place, or a combination thereof have a similarity above a threshold value; and
selecting the at least one message propagation method from the plurality of differentiated message propagation methods that uses a mean aggregator.

10. The method of claim 1, further comprising:
determining that the place categories of the one or more neighboring nodes, the place, or a combination thereof have a similarity below a threshold value; and
selecting the at least one message propagation method from the plurality of differentiated message propagation methods that uses a minimum pooling aggregator or a maximum pooling aggregator.

11. The method of claim 1, wherein the at least one message propagation method is selected on a node-by-node basis.

12. The method of claim 1, further comprising:
storing the predicted category of the designated place in a geographic database.

13. An apparatus comprising:
at least one processor; and
at least one memory including computer program code for one or more programs,
the at least one memory and the computer program code configured to, within the at least one processor, cause the apparatus to perform at least the following,
receive a place graph comprising a place located in a geographic area as a place node and one or more neighbor nodes representing one or more neighboring places in the geographic area;
encode the place graph using a graph convolutional network; and
use the graph convolutional network with the encoded place graph to predict a category of the place; and
provide the predicted category of the place as an output.

14. The apparatus of claim 13, wherein the apparatus is further caused to:
determine demographic information associated with the designated place, one or more neighboring places of the designated place, the geographic area, or a combination thereof,
wherein the predicted category is further based on the demographic information.

15. The apparatus of claim 14, wherein the apparatus is further caused to:
determine a compatibility of the predicted category with the demographic information; and
revising the predicted category based on the compatibility.

16. The apparatus of claim 15, wherein the graph convolutional network was trained using at least one message propagation method of a plurality of differentiated message propagation methods.

17. A non-transitory computer-readable storage medium for providing map embedding analytics for a neural network, carrying one or more sequences of one or more instructions which, when executed by one or more processors, cause an apparatus to perform:
receiving a place graph comprising one or more place nodes representing one or more places in the geographic area and one or more edges representing one or more neighboring relationships between the one or more places;
encoding the place graph using a graph convolutional network, wherein the graph convolutional network was trained using at least one message propagation method of a plurality of differentiated message propagation methods; and
using the graph convolutional network with the encoded place graph to predict a category of a designated place; and
providing the predicted category of the designated place as an output.

18. The non-transitory computer-readable storage medium of claim 17, wherein the apparatus is caused to further perform:
determining demographic information associated with the designated place, one or more neighboring places of the designated place, the geographic area, or a combination thereof,
wherein the predicted category is further based on the demographic information.

19. The non-transitory computer-readable storage medium of claim 18, wherein the apparatus is caused to further perform:
determining a compatibility of the predicted category with the demographic information; and
revising the predicted category based on the compatibility.

20. The non-transitory computer-readable storage medium of claim 19, wherein the apparatus is caused to further perform:
determining a weighting of the predicted category based on a level of the compatibility of the predicted category and the demographic information.
